(19) United States
(12) Patent Application Publication
(10) Pub. No.: US 2010/0003472 A1
(43) Pub. Date: Jan. 7, 2010

(54) LUMINESCENT ARTICLE

(75) Inventor: Tsung-Chi LIEN, Guangzhou (CN)

Correspondence Address: Kirschstein, Israel, Schiffmiller & Pieroni, P.C., 425 FIFTH AVENUE, 5TH FLOOR, NEW YORK, NY, 10016-2223, US

(73) Assignee: E. S. ORIGINALS, INC., New York, NY (US)

(21) Appl. No.: 12/496,016

(22) Filed: Jul. 1, 2009

(30) Foreign Application Priority Data
Jul. 1, 2008 (CN) ZL200820050039.4

(51) Int. Cl. B32B 3/10; B05D 5/06

(52) U.S. Cl. 428/195.1; 427/64

(57) ABSTRACT

A luminescent article is made by applying a base layer on the article, by applying an intermediate layer on the base layer, and by applying a luminescent layer on the intermediate layer. Color fading of the luminescent layer is minimized. The multiple layers create a pronounced three-dimensional decorative impact, with a longer and brighter glow.

### BACKGROUND OF THE INVENTION

This invention generally relates to luminescent articles, and in particular, to a luminescent shoe upper or outsole. Luminescent, such as phosphorescent or fluorescent, materials are capable of producing light. Luminescent materials typically operate by absorbing a range of excitation radiation wavelengths, by converting this excitation radiation to radiation in the visible spectrum, and by emitting the converted radiation as light visible to the human eye. Phosphorescent materials are those materials that are capable of producing visible light for a period of time after the initial absorption of excitation radiation has stopped. Fluorescent materials are those materials that tend to stop emitting visible light once the excitation radiation has stopped. This light-emitting phenomenon is generally recognized as a “glow in the dark” characteristic of the luminescent material. For the purposes of this invention, luminescent materials, such as photoluminescent, fluorescent, or phosphorescent materials in any combination, are referred to herein as “luminescent or light-emitting materials”.

Luminescent materials have been used in a variety of commercial applications, such as warning signs, marking of vital machinery, dial illumination, directional signs on walls of underground stations, garages, hallways, and have been applied to helmets as used in fire departments, accident prevention, etc. Luminescent materials have also found application for use on protective clothing, sports equipment and a variety of toys and shoes, where the effect of glowing in the dark provides amusement, ornamental and/or safety features. The wearers of shoes decorated with, or made from, luminescent materials are easily identified at night, or in the dark. Such luminescent shoes find particular use by pedestrians and bicyclists. In addition, children are intrigued by the glow in the dark feature of the shoes and are inclined to wear these types of luminescent shoes more than plain shoes and tend to learn how to put them on faster. Further, glow in the dark shoes enable wearers to locate their shoes quickly and easily at night, or in dimly lit environments. Prior art patents include U.S. Pat. No. 4,640,797 and U.S. Pat. No. 4,629,583, which disclose phosphorescent polymer containing compositions suitable for use in footwear and phosphorescent shoes, shoe soles, and other molded or extruded shoe pans.

Commercially available phosphors include zinc sulfide, zinc cadmium sulfide and alkaline earth sulfides, with or without a trace of activators, such as silver, copper or manganese to provide the desired rapid activation of the phosphorescent material in providing a luminescent image. In some situations, an intense luminescent image is desired, which may require high concentrations of phosphor in the phosphorescent material in the range of 20 to 30%. Zinc sulfide is typically used in a proportion with 20 to 50 parts per million of a copper activator. Zinc sulfide glows a green-yellow color after exposure to white light. A mixture of 50% zinc sulfide and 50% cadmium sulfide with the copper activator glows an orange-red color.

As advantageous as the known luminescent shoes have been, “graying” or color fading can occur should the luminescent material be exposed to direct ultraviolet light and high humidity conditions for a long period of time. This is particularly applicable with zinc sulfides and zinc cadmium sulfides. When applied directly in a single layer to a shoe upper for decorative purposes, the luminescent material can easily become discolored and dislodged from the upper, because the single layer of the luminescent material is thin and only weakly attached to the upper. The single layer of the luminescent material has little depth, and as a result, the decorative effect is minimal and has little three-dimensional impact. A need exists for an improved luminescent shoe, which would provide a longer and brighter glow.

### SUMMARY OF THE INVENTION

One aspect of this invention is directed to a luminescent article, for example, a shoe, and a method of making the same. A base layer is initially applied on the article, preferably as a white layer screen-printed on the article, for example, on an upper of the shoe. The upper can be constituted of any material, e.g., leather, vinyl, natural or synthetic plastic material, cloth, rubber, etc. Thereupon, an intermediate layer is applied on the base layer, preferably as a golden oil layer screen-printed on the base layer. Thereupon, a luminescent layer is applied on the intermediate layer, preferably by being screen-printed on the intermediate layer. Each layer is advantageously applied in a different pattern. The luminescent layer is advantageously formed of multiple successive screen-printings on the intermediate layer.

According to this invention, color fading of the luminescent layer is minimized. The multiple layers create a pronounced three-dimensional decorative impact, with a longer and brighter glow. The luminescent article need not be a shoe, but can be any object, especially one to be adorned, e.g., a backpack, a bag, clothing, accessories, etc.

The novel features which are considered as characteristic of the invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a side elevational view of a luminescent shoe made in accordance with this invention; and

FIG. 2 is an enlarged sectional view taken in the direction of the arrows on the line 2-2 of FIG. 1.

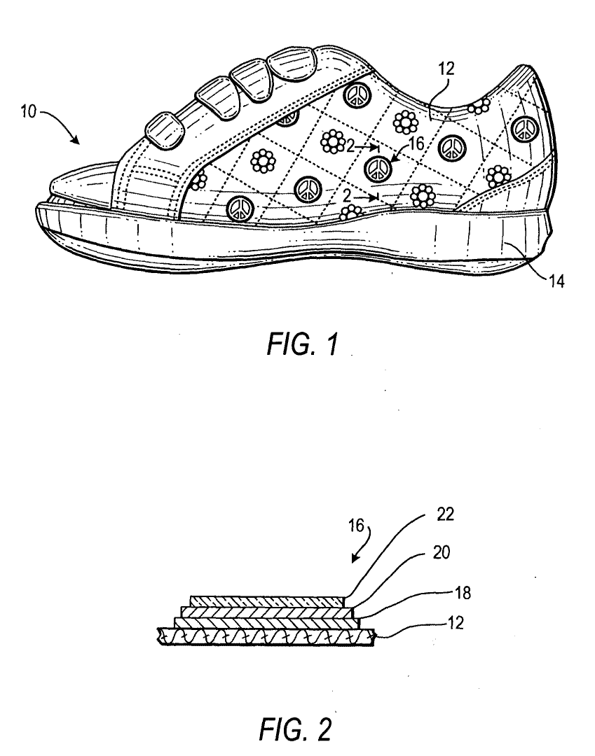

### DETAILED DESCRIPTION OF THE PREFERRED EMBODIMENTS

Referring now to the drawings, reference numeral 10 generally identifies a luminescent shoe having an upper 12 and an outsole 14. The upper 12 can be constituted of any material, e.g., leather, vinyl, natural or synthetic plastic material, cloth, rubber, etc. The outsole 14 is preferably constituted of a rubber or plastic material. Other configurations for the shoe are contemplated for this invention. Although a shoe has been illustrated, this was done only for ease of illustration, since the instant invention has utility for providing luminescence to any article or object, especially one to be adorned, e.g., a backpack, a bag, clothing, accessories, hats, gloves, socks, etc.

The luminescent shoe 10 is decorated with one or more luminescent decorations 16 each made, as better seen in FIG. 2, by initially applying a base layer 18 on the shoe 10, preferably as a white layer or flood coating screen-printed on the upper 12 of the shoe 10. Thereupon, an intermediate layer 20 is applied on the base layer 18, preferably as a golden oil layer or highlight coating screen-printed on the base layer 18. Thereupon, a luminescent layer 22 is applied on the intermediate layer 20, preferably by being screen-printed on the intermediate layer 20. Each layer 18, 20, 22 is advantageously applied in a different pattern. The luminescent layer 22 is advantageously formed of multiple successive screen-printings or luminescent coatings on the intermediate layer 20. Hence, the luminescent layer 22 is advantageously printed thickly and is elevated well above the upper, thereby creating a pronounced three-dimensional decorative impact.

The luminescent layer 22 preferably includes zinc sulfide, zinc cadmium sulfide and alkaline earth sulfides, with or without a trace of activators, such as silver, copper or manganese. Zinc sulfide is typically used in a proportion with 20 to 50 parts per million of a copper activator. Zinc sulfide glows a green-yellow color after exposure to white light.

In accordance with this invention, color fading is minimized. The luminescent layer 22 strongly adheres to the upper due to the presence of the base layer 18 an the intermediate layer 20. The luminescent shoe 10 is thus provided with a longer and brighter glow.

It will be understood that each of the elements described above, or two or more together, also may find a useful application in other types of constructions differing from the types described above. The decoration 16 need not be the peace symbol illustrated in the drawing, but can be any alphanumerical or pictoral representation or ornamental design.

While the invention has been illustrated and described as embodied in a luminescent article and method of making the same, it is not intended to be limited to the details shown, since various modifications and structural changes may be made without departing in any way from the spirit of the present invention. For example, in the case where the article is a shoe, the luminescent layer 22 need not only be applied to the upper 12, but could be applied to other parts of the shoe, e.g., the outsole 14, or to its laces, its tongue, its straps, its midsole, etc. For other articles, the luminescent layer 22 can be applied anywhere.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention and, therefore, such adaptations should and are intended to be comprehended within the meaning and range of equivalence of the following claims.

What is claimed as new and desired to be protected by Letters Patent is set forth in the appended claims.

1. A luminescent article, comprising:
a base layer applied on the article;
an intermediate layer applied on the base layer; and
a luminescent layer applied on the intermediate layer.

2. The luminescent article of claim 1, wherein the base layer is printed on the article, wherein the intermediate layer is printed on the base layer, and wherein the luminescent layer is printed on the intermediate layer.

3. The luminescent article of claim 1, wherein the base layer is a white layer screen-printed on the article.

4. The luminescent article of claim 1, wherein the intermediate layer is an oil layer screen-printed on the base layer.

5. The luminescent article of claim 4, wherein the oil layer is constituted of a golden oil.

6. The luminescent article of claim 1, wherein the luminescent layer is screen-printed on the intermediate layer.

7. The luminescent article of claim 1, wherein each layer is applied in a different pattern.

8. The luminescent article of claim 1, wherein the luminescent layer is formed of multiple successive printings on the intermediate layer.

9. A luminescent article, comprising:
a white base layer screen-printed on the article;
an intermediate oil layer screen-printed on the white base layer; and
a luminescent layer screen-printed on the intermediate oil layer.

10. The luminescent article of claim 9, wherein each layer is applied in a different pattern.

11. The luminescent article of claim 9, wherein the luminescent layer is formed of multiple successive printings on the intermediate oil layer.

12. The luminescent article of claim 9, wherein the article is a shoe.

13. A method of making a luminescent article, comprising the steps of:
applying a base layer on the article;
applying an intermediate layer on the base layer; and
applying a luminescent layer on the intermediate layer.

14. The method of claim 13, and printing the base layer on the article, and printing the intermediate layer on the base layer, and printing the luminescent layer on the intermediate layer.

15. The method of claim 13, and screen-printing the base layer as a white layer on the article.

16. The method of claim 13, and screen-printing the intermediate layer as an oil layer on the base layer.

17. The method of claim 16, and constituting the oil layer as a golden oil.

18. The method of claim 13, and screen-printing the luminescent layer on the intermediate layer.

19. The method of claim 13, and applying each layer in a different pattern.

20. The method of claim 13, and forming the luminescent layer as multiple successive printings on the intermediate layer.
